(19) United States
(12) Patent Application Publication
(10) Pub. No.: US 2016/0305561 A1
(43) Pub. Date: Oct. 20, 2016

(54) WATER FILTERING DEVICE SAFETY VALVE

(71) Applicant: Xiamen Runner Industrial Corporation, Xiamen (CN)

(72) Inventor: Yong-sheng Ding, Xiamen (CN)

(21) Appl. No.: 15/051,508

(22) Filed: Feb. 23, 2016

(30) Foreign Application Priority Data
Apr. 15, 2015 (CN) 201520224295.0

(51) Int. Cl. F16K 17/02; B01D 35/147

(52) U.S. Cl. CPC F16K 17/02; B01D 35/1475

(57) ABSTRACT

A water filtering device safety valve, comprising: a valve body, provided with a first water inlet port and a second water inlet port, and a first water outlet port and a second water outlet port; a valve core; a central valve rod, connected rigidly to a lower portion of the valve core; a water stop pad, disposed in a lower portion inner chamber of the valve body, and can be slid upward or downward; a cone shape head, disposed in a lower portion of the water stop pad; a pressure release through hole, disposed in a central portion of the water stop pad, a lower portion of the central valve rod is disposed over and opposite to the pressure release through hole; and a separation body, used to separate an upper portion inner chamber and a lower portion inner chamber of the valve body.

### BACKGROUND OF THE INVENTION

1. Field of the Invention

The present invention relates to a safety valve, and in particular to a water filtering device safety valve.

2. The Prior Arts

Presently on the market, the filtering device is designed to be connected to the front end of a water dispenser faucet. When the water dispenser faucet is closed, the filtering device is connected directly to the water pipes of the local water supply plant. As such, when the pressure in the water pipe is increased suddenly, it could produce great impact on the filtering device, or it could even break the filtering device, to cause property damage to the user.

Therefore, at present, the design and performance of the filtering device is not quite satisfactory, and it leaves much room for improvement.

### SUMMARY OF THE INVENTION

In view of the problems and drawbacks of the prior art, the present invention provides a water filtering device safety valve, that is optimized in design and simple in construction, to avoid the water filtering device being subjected to high pressure and be damaged.

In order to achieve the objective mentioned above, the present invention provides a water filtering device safety valve, including: a valve body, a valve core, a central valve rod, a water stop pad, a cone shape head, a pressure release through hole, and a separation body. Wherein, the valve body is provided with a first water inlet port and a second water inlet port, and a first water outlet port and a second water outlet port. The first water inlet port is connected to water pipes of a local water supply plant, while the second water inlet port is connected to a water output end of a filtering device. The first water outlet port is connected to a water input end of the filtering device, while the second water outlet port is connected to a water dispenser.

The valve core is disposed vertically in an upper portion inner chamber of the valve body, and can be slid upward or downward. The central valve rod is connected rigidly in a lower portion of the valve core. The water stop pad is disposed in a lower portion inner chamber of the valve body, and can be slid upward or downward. The cone shape head is disposed in a lower portion of the water stop pad. The pressure release through hole is disposed in a central portion of the water stop pad, a lower portion of the central valve rod is disposed over and opposite to the pressure release through hole. And the separation body is used to separate an upper portion inner chamber and a lower portion inner chamber of the valve body, while the central valve rod penetrates and is disposed in the separation body.

A back pressure chamber is disposed between an upper portion of the water stop pad, and a lower portion of the separation body; while a through hole connecting the first water inlet port and the back pressure chamber, is disposed on the water stop pad and close to an end of the first water inlet port.

An air vent hole in communication with outside of the valve body is disposed on the valve body, and between a lower surface of the valve core and an upper portion of the separation body.

A spring is disposed between the lower surface of the valve core and the upper portion of the separation body.

A sealing pad is disposed in a lower portion of the central valve rod, to block the pressure release through hole.

A cone shape opening is disposed in the lower portion inner chamber of the valve body, to match and act in cooperation with the cone shape head.

A sealing ring is disposed between a lower portion outer surface of the valve core and the valve body, such that an upper branch chamber is formed on the sealing ring, the second water inlet port and the second water outlet port.

The operation principles of the water filtering device safety valve are described in detail as follows.
When the water dispenser faucet is opened

Water pressure in the upper branch chamber is close to 0 Mpa, at this time, due to the driving of the spring, the valve core brings the central valve rod to move upward together. Then, the upward movement of the central valve rod brings the water stop pad to open the pressure release through hole, such that water in the back pressure chamber flows into the filtering device through the pressure release hole. As such, the pressure in the back pressure chamber is reduced, and that makes the pressure below the water stop pad is greater than the pressure above the water stop pad, such that the water stop pad is moved upward to open the back pressure chamber, to open the water route at the front end of the filtering device.
When the water dispenser faucet is closed

Water pressure in the upper branch chamber is increased rapidly, at this time, due to action of water pressure, the valve core moves downward to press the spring to move downward, to bring the central valve rod to move downward to close the pressure release through hole. At this time, the pressure in the back pressure chamber is increased rapidly, to force the water stop pad to move downward to close the main water route (water route of the first water inlet port and the first water output port). After the main water route is closed, due to the compressibility of the water stop pad, the valve core is still able to move downward for a certain distance, to increase the volume of the upper branch chamber. Therefore, the pressure on the rear end of the filtering device is reduced, such that the pressure on the front end of the filtering device is reduced, thus protecting the filtering device from being subjected constantly to high pressure.

In the present invention, the pressure difference between water dispenser faucet open and close is used to control the open and close of the safety valve. When the water dispenser faucet is closed, the safety valve closes the front end water route of the filtering device, to avoid the filtering device being exerted high pressure for long period of time. The water filtering device safety valve is convenient to install, and is suitable to use with various types of filtering devices.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a water filtering device safety valve in an opened state according to an embodiment of the present invention;

FIG. 2 is a schematic diagram of a water filtering device safety valve in a closed state according to an embodiment of the present invention;

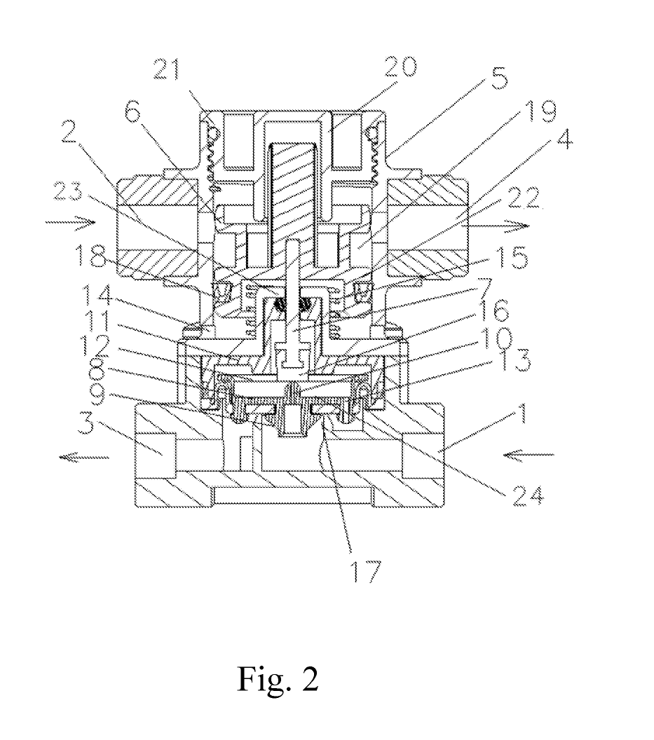

FIG. 3 is an exploded view of a water filtering device safety valve according to an embodiment of the present invention; and

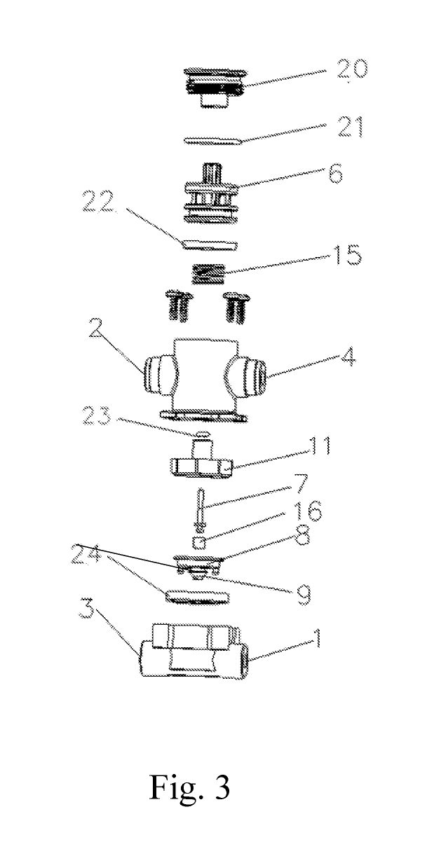

FIG. 4 is a schematic diagram of a water filtering device safety valve in operation according to an embodiment of the present invention.

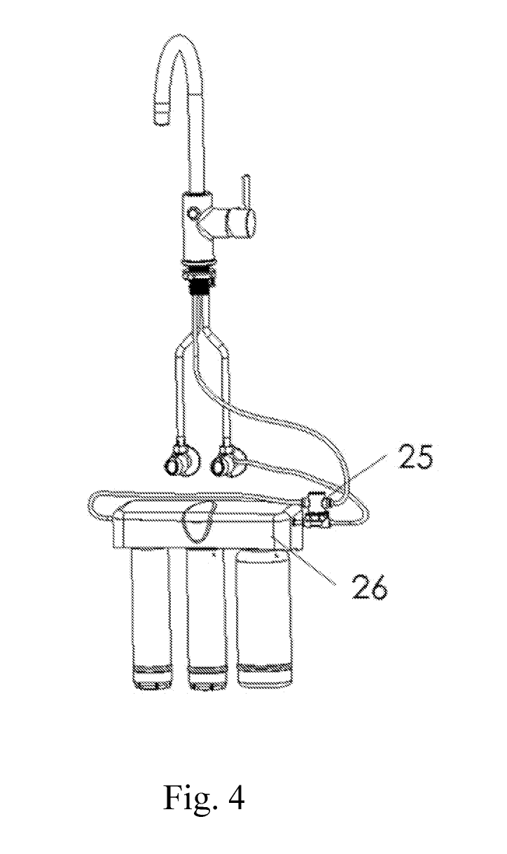

### DETAILED DESCRIPTION OF THE PREFERRED EMBODIMENT

The purpose, construction, features, functions and advantages of the present invention can be appreciated and understood more thoroughly through the following detailed description with reference to the attached drawings.

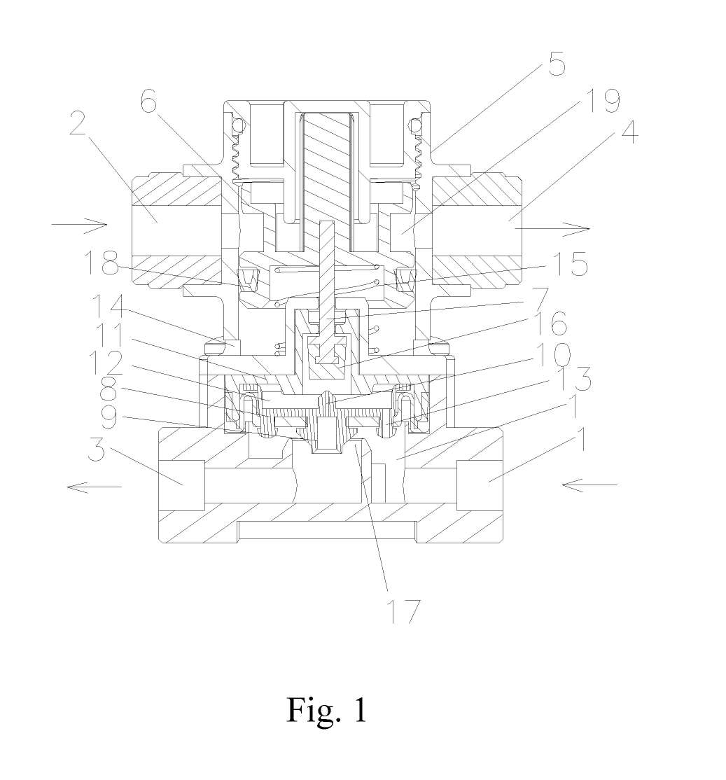

Refer to FIGS. 1,2,3, and 4 respectively for a schematic diagram of a water filtering device safety valve in an opened state according to an embodiment of the present invention; a schematic diagram of a water filtering device safety valve in a closed state according to an embodiment of the present invention; an exploded view of a water filtering device safety valve according to an embodiment of the present invention; and a schematic diagram of a water filtering device safety valve in operation according to an embodiment of the present invention.

As shown in FIGS. 1,2,3, and 4, the present invention provides a water filtering device safety valve, including: a valve body 5, a valve core 6, a central valve rod 7, a water stop pad 8, a cone shape head 9, a pressure release through hole 10, and a separation body 11. Wherein, the valve body 5 is provided with a first water inlet port 1 and a second water inlet port 2, and a first water outlet port 3 and a second water outlet port 4. The first water inlet port 1 is connected to water pipes of a local water supply plant, while the second water inlet port 2 is connected to a water output end of a filtering device. The first water outlet port 3 is connected to a water input end of the filtering device, while the second water outlet port 4 is connected to a water dispenser. The valve core 6 is disposed vertically in an upper portion inner chamber of the valve body 5, and can be slid upward or downward. The central valve rod 7 is connected rigidly to a lower portion of the valve core 6. The water stop pad 8 is disposed in a lower portion inner chamber of the valve body 5, and can be slid upward or downward. The cone shape head 9 is disposed in a lower portion of the water stop pad 8. The pressure release through hole 10 is disposed in a central portion of the water stop pad 8, a lower portion of the central valve rod 7 is disposed over and opposite to the pressure release through hole 10. And the separation body 11 is used to separate an upper portion inner chamber and a lower portion inner chamber of the valve body 5, while the central valve rod 7 penetrates and is disposed in the separation body 11.

In order to optimize design, a back pressure chamber 12 is disposed between an upper portion of the water stop pad 8, and a lower portion of the separation body 11. A through hole 13 connecting the first water inlet port 1 and the back pressure chamber 12, is disposed on the water stop pad 8 and close to an end of the first water inlet port 1.

An air vent hole 14 in communication with outside of the valve body 5 is disposed on the valve body 5, and between a lower surface of the valve core 6 and the upper portion of the separation body 11.

A spring 15 is disposed between the lower surface of the valve core 6 and the upper portion of the separation body 11.

A sealing pad 16 is disposed in a lower portion of the central valve rod 7, to block the pressure release through hole 10.

A cone shape opening 17 is disposed in the lower portion inner chamber of the valve body 5, to match and act in cooperation with the cone shape head 9.

A sealing ring 18 is disposed a lower portion outer surface of the valve core 6 and the valve body 5, such that an upper branch chamber 19 is formed on the sealing ring 18, the second water inlet port 2 and the second water outlet port 4.

The operation principles of the water filtering device safety valve are described in detail as follows.
When the water dispenser faucet is opened

Water pressure in the upper branch chamber 19 is close to 0 Mpa, at this time, due to the driving of the spring 15, the valve core 6 brings the central valve rod 7 to move upward together. Then, the upward movement of the central valve rod 7 brings the water stop pad 8 to open the pressure release through hole 10, such that water in the back pressure chamber 12 flows into the filtering device through the pressure release through hole 10. As such, the pressure in the back pressure chamber 12 is reduced, and that makes the pressure below the water stop pad 8 is greater than the pressure above the water stop pad 8, such that the water stop pad 8 is moved upward to open the back pressure chamber 12, to open the water route at the front end of the filtering device.
When the water dispenser faucet is closed

Water pressure in the upper branch chamber 19 is increased rapidly, at this time, due to the pressure of water, the valve core 6 moves downward to press the spring 15 to move downward, to bring the central valve rod 7 to move downward to close the pressure release through hole 10. At this time, the pressure in the back pressure chamber 12 is increased rapidly, to force the water stop pad 8 to move downward to close the main water route (water routes of the first water inlet port 1 and the first water output port 3). After the main water route is closed, due to the compressibility of the water stop pad 8, the valve core 6 is still able to move downward for a certain distance, to increase the volume of the upper branch chamber 19. Therefore, the pressure on the rear end of the filtering device is reduced, such that the pressure on the front end of the filtering device is reduced, thus protecting the filtering device from being subjected to high pressure.

In the present invention, the pressure difference between water dispenser faucet open and close is used to control the open and close of the water filtering device safety valve. When the faucet is closed, the safety valve closes the front end water route of the filtering device, to avoid the filtering device being exerted high pressure for a long period of time. The water filtering device safety valve is convenient to install, and is suitable to use with various types of filtering devices.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A water filtering device safety valve, comprising:
a valve body, provided with a first water inlet port and a second water inlet port, and a first water outlet port and a second water outlet port, the first water inlet port is connected to water pipes of a local water supply plant, while the second water inlet port is connected to a water output end of a filtering device, the first water outlet port is connected to a water input end of the filtering device, while the second water outlet port is connected to a water dispenser;
a valve core, disposed vertically in an upper portion inner chamber of the valve body, and is slidable upward or downward;
a central valve rod, connected rigidly in a lower portion of the valve core;
a water stop pad, disposed in a lower portion inner chamber of the valve body, and is slidable upward or downward;
a cone shape head, disposed in a lower portion of the water stop pad;
a pressure release through hole, disposed in a central portion of the water stop pad, a lower portion of the central valve rod is disposed over and opposite to the pressure release through hole; and
a separation body, used to separate an upper portion inner chamber and a lower portion inner chamber of the valve body, while the central valve rod penetrates and is disposed in the separation body.

2. The water filtering device safety valve as claimed in claim 1, wherein a back pressure chamber is disposed between an upper portion of the water stop pad, and a lower portion of the separation body; a through hole connecting the first water inlet port and the back pressure chamber, is disposed on the water stop pad and close to an end of the first water inlet port.

3. The water filtering device safety valve as claimed in claim 1, wherein an air vent hole in communication with outside of the valve body is disposed on the valve body, and between a lower surface of the valve core and an upper portion of the separation body.

4. The water filtering device safety valve as claimed in claim 1, wherein a spring is disposed between the lower surface of the valve core and the upper portion of the separation body.

5. The water filtering device safety valve as claimed in claim 1, wherein a sealing pad is disposed in a lower portion of the central valve rod, to block the pressure release through hole.

6. The water filtering device safety valve as claimed in claim 1, wherein a cone shape opening is disposed in the lower portion inner chamber of the valve body, to match and act in cooperation with the cone shape head.

7. The water filtering device safety valve as claimed in claim 1, wherein a sealing ring is disposed between a lower portion outer surface of the valve core and the valve body, such that an upper branch chamber is formed on the sealing ring, the second water inlet port and the second water outlet port.
